(19) United States
(12) Patent Application Publication
(10) Pub. No.: US 2007/0170320 A1
(43) Pub. Date: Jul. 26, 2007

(54) ADJUSTABLE MOUNT FOR HEAT-DISSIPATING DEVICES

(75) Inventor: ZHENG-HENG SUN, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Taipei Hsien (TW)

(21) Appl. No.: 11/309,148

(22) Filed: Jun. 28, 2006

(30) Foreign Application Priority Data
Jan. 24, 2006 (CN) 200610033485.X

(51) Int. Cl. F16M 11/02

(52) U.S. Cl. 248/177.1

(57) ABSTRACT

A mounting apparatus is provided for receiving a heat-dissipating device thereon. The mounting apparatus includes a connecting element, and an adjustable supporting element, which allows easy selection of direction of airflow of the heat-dissipating device mounted thereon. The connecting element includes a first mounting element for mounting the heat-dissipating device, and a second mounting element for mounting the adjustable supporting element.

### 1. FIELD OF THE INVENTION

The present invention relates to mounting apparatuses, and particularly to a mounting apparatus for receiving a heat-dissipating device thereon.

### 2. DESCRIPTION OF RELATED ART

When testing an electrical product such as a motherboard, components on the product may produce heat that needs to be dissipated, thereby increasing test veracity. A conventional method for dissipating the heat is to provide a heat-dissipating device such as a blower or a fan, aimed at the product under testing. However, the device is usually fixed in place so a direction of airflow is not easily adjusted to achieve an optimal effectiveness in dissipating the heat.

What is desired, therefore, is to provide an apparatus which can mount a heat-dissipating device and facilitate changing the orientation of the heat-dissipating device thereby directing airflow according to need.

### SUMMARY OF THE INVENTION

In one preferred embodiment, a mounting apparatus is provided for receiving a heat-dissipating device thereon. The mounting apparatus includes a connecting element, and an adjustable supporting element, which allows easy selection of direction of airflow of the heat-dissipating device mounted thereon. The connecting element includes a first mounting element for mounting the heat-dissipating device, and a second mounting element for mounting the adjustable supporting element.

Other advantages and novel features will become more apparent from the following detailed description when taken in conjunction with the accompanying drawings, in which:

### BRIEF DESCRIPTION OF THE DRAWINGS

FIG. 1 is an exploded, isometric view of a mounting apparatus in accordance with a first preferred embodiment of the present invention, together with a blower;

FIG. 2 is an assembled view of FIG. 1;

FIG. 3 is an exploded, isometric view of a mounting apparatus in accordance with a second preferred embodiment of the present invention, together with a fan; and

FIG. 4 is an assembled view of FIG. 3.

### DETAILED DESCRIPTION OF THE INVENTION

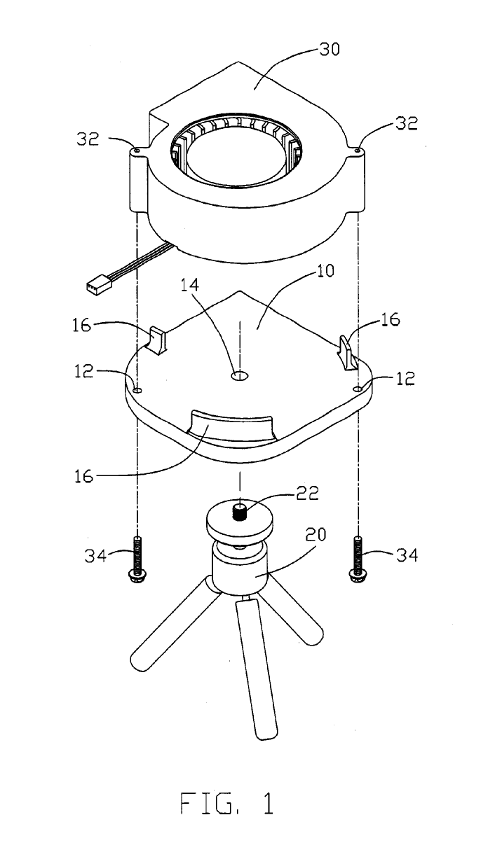

Referring to FIG. 1, a mounting apparatus in accordance with a first preferred embodiment of the present invention is provided to receive a heat-dissipating device such as a blower 30. In this embodiment, the blower 30 includes two threaded holes 32.

The mounting apparatus includes a connecting element 10, and an adjustable supporting element such as a tripod 20. The tripod 20 includes a threaded post 22 at a top thereof. The connecting element 10 includes a base to locate the heat-dissipating device such as the blower 30 thereon, a first mounting element such as two through holes 12 corresponding to the two threaded holes 32 of the blower 30 formed in a peripheral portion of the base, and a second mounting element such as a threaded hole 14 corresponding to the threaded post 22 of the tripod 20 formed in a central portion of the base. A plurality of positioning elements 16 is formed extending up from one side of the connecting element 10 for retaining the blower 30.

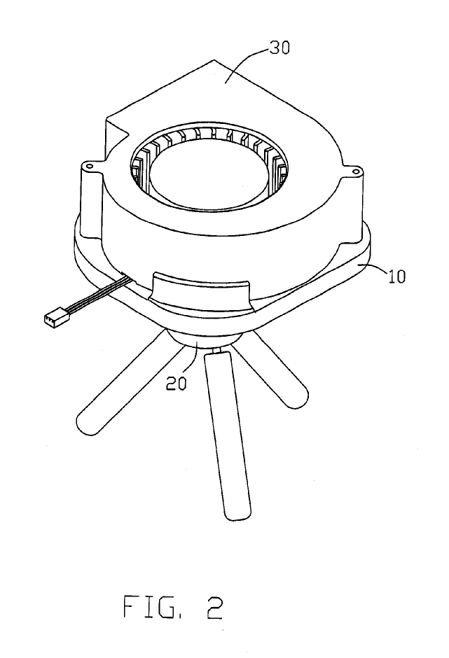

Referring also to FIG. 2, in assembly, the connecting element 10 is mounted on the tripod 20 by the threaded post 22 screwing into the threaded hole 14. Then, the blower 30 is received by the positioning elements 16 and mounted to the connecting element 10 by known means such as two screws 34 extending through the through holes 12 of the connecting element 10, and into the threaded holes 32 of the blower 30. When the blower 30 is working for dissipating heat of an electrical product (not shown), the direction of airflow of the blower 30 is varied by adjusting the angles of the tripod 20 according to need, thereby achieving an optimal effectiveness in dissipating the heat of the electrical product.

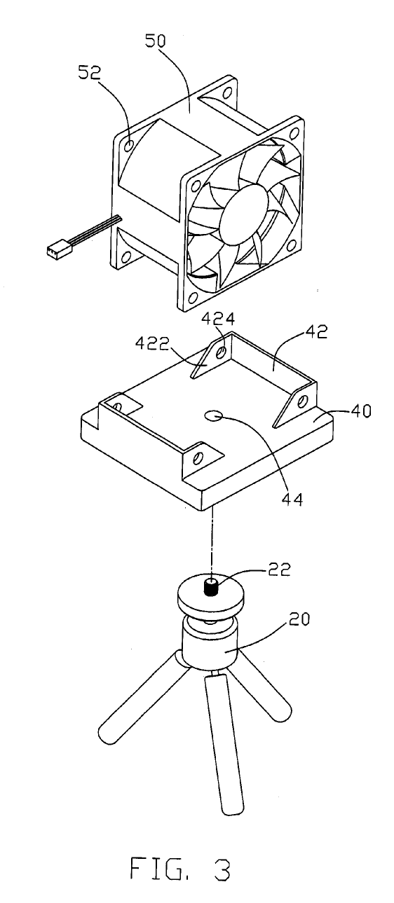

Referring also to FIG. 3, a mounting apparatus in accordance with a second preferred embodiment of the present invention is provided to receive a heat-dissipating device such as a fan 50. In this embodiment, the fan 50 includes a pair of aligned mounting holes 52 defined in each of four corners of the fan 50.

The mounting apparatus includes a connecting element 40, and an adjustable supporting element such as the tripod 20. A pair of retaining portions 42 extends up from two opposite edges of the connecting element 40. Each of the retaining portions 42 is generally U-shaped, and includes two parallel arms 422. Each of the arms 422 defines a through hole 424 therein corresponding to the mounting hole 52 of the fan 50. The connecting element 40 further includes a threaded hole 44 corresponding to the threaded post 22 of the tripod 20.

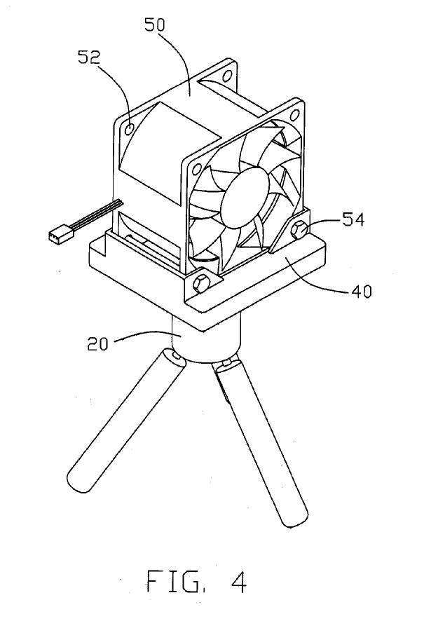

Referring also to FIG. 4, in assembly, the connecting element 40 is mounted on the tripod 20 by the threaded post 22 screwing into the threaded hole 44. Then, the fan 50 is received by the retaining portions 42 and mounted on the connecting element 40 by known means such as two screws 54 extending through corresponding through holes 424 of the connecting element 40 and corresponding mounting holes 52 of the fan 50. Like the blower 30, when the fan 50 is working for dissipating heat of an electrical product (not shown), the direction of airflow of the fan 50 is varied by adjusting the angles of the tripod 20 according to need, thereby achieving an optimal effectiveness in dissipating the heat of the electrical product.

It is to be understood, however, that even though numerous characteristics and advantages of the preferred embodiments have been set forth in the foregoing description, together with details of the structures and functions of the embodiments, the disclosure is illustrative only, and changes may be made in detail, especially in matters of shape, size, equivalent material and arrangement of parts within the principles of the invention to the full extent indicated by the broad general meaning of the terms in which the appended claims are expressed.

What is claimed is:

1. A mounting apparatus for receiving a heat-dissipating device thereon, comprising:
a connecting element comprising a first mounting element for mounting the heat-dissipating device, and a second mounting element; and
an adjustable supporting element connected to the connecting element via the second mounting element, wherein angles of the adjustable supporting element are variable.

2. The mounting apparatus as claimed in claim 1, wherein the adjustable supporting element is a tripod.

3. The mounting apparatus as claimed in claim 2, wherein the second mounting element comprises a threaded hole defined in the connecting element, the tripod forms a threaded post at a top thereof to engage in the threaded hole.

4. The mounting apparatus as claimed in claim 1, wherein the heat-dissipating device is a blower.

5. The mounting apparatus as claimed in claim 4, wherein the first mounting element comprises two through holes defined in the connecting element corresponding to two through holes of the blower.

6. The mounting apparatus as claimed in claim 5, wherein the connecting element further includes a plurality of positioning elements formed extending up from one side of the connecting element to retain the blower.

7. The mounting apparatus as claimed in claim 1, wherein the heat-dissipating device is a fan.

8. The mounting apparatus as claimed in claim 7, wherein the first mounting element comprises two retaining portions formed extending up on the connecting element, each of the retaining portions includes two parallel arms, and each of the arms defines a through hole therein.

9. A method for adjusting angles of a heat-dissipating device, comprising the steps of:
providing a connecting element comprising a first mounting element for mounting the heat-dissipating device, and a second mounting element;
providing an adjustable supporting element whose angles can be varied;
mounting the heat-dissipating device on the connecting element via the first mounting element; and
mounting the connecting element on the adjustable supporting element via the second mounting element.

10. The method as claimed in claim 9, wherein the adjustable supporting element is a tripod.

11. The method as claimed in claim 10, wherein the second mounting element comprises a threaded hole defined in the connecting element, the tripod forms a threaded post at a top thereof to engage in the threaded hole.

12. The method as claimed in claim 9, wherein the heat-dissipating device is a blower.

13. The method as claimed in claim 12, wherein the first mounting element comprises two through holes defined in the connecting element corresponding to two through holes of the blower.

14. The method as claimed in claim 13, wherein the connecting element further includes a plurality of positioning elements formed extending up from one side of the connecting element to retain the blower.

15. The method as claimed in claim 9, wherein the heat-dissipating device is a fan.

16. The method as claimed in claim 15, wherein the first mounting element comprises two retaining portions formed extending up on the connecting element, each of the retaining portions includes two parallel arms, and each of the arms defines a through hole therein.

17. An assembly comprising:
a device providing a predetermined function;
an adjustable supporting element removably attachable to said device so as to provide a positioning support for said device and define orientation of said device, said adjustable supporting element comprising means to adjust said orientation of said device when said adjustable supporting element is separably attached to said device to support said device; and
a connecting element separably installable between said device and said adjustable supporting element in order to attach said adjustable supporting element to said device, said connecting element comprising a base to locate said device thereat, a first mounting element defined in a periphery portion of said base to secure said device to said connecting element, and a second mounting element defined in a central portion of said base to secure said adjustable supporting element to said connecting element.
